(19) United States
(12) Patent Application Publication
(10) Pub. No.: US 2011/0245359 A1
(43) Pub. Date: Oct. 6, 2011

(54) METHODS OF PREPARING HYBRID AEROGELS

(76) Inventors: Peter D. Condo, Lake Elmo, MN (US); Jayshree Seth, Woodbury, MN (US); Jung-Sheng Wu, Woodbury, MN (US); Neeraj Sharma, Woodbury, MN (US); Lian Soon Tan, Woodbury, MN (US)

(21) Appl. No.: 13/133,711

(22) PCT Filed: Dec. 1, 2009
(86) PCT No.: PCT/US09/66245

§ 371 Date: Jun. 9, 2011

Related U.S. Application Data
(60) Provisional application No. 61/138,571, filed on Dec. 18, 2008.

(51) Int. Cl. C08J 9/28; C08G 77/38

(52) U.S. Cl. 521/63

(57) ABSTRACT

Methods of preparing hybrid aerogels are described. The methods include co-condensing a metal oxide precursor and an organo-functional metal oxide precursor, and crosslinking the organo-functional groups with an ethylenically-unsaturated crosslink agent. Thermal energy and actinic radiation crosslinking are described. Both supercritical aerogel and xerogels, including hydrophobic supercritical aerogel and xerogels, are described. Aerogel articles, including flexible aerogel articles are also disclosed.

### FIELD

The present disclosure relates to methods of making inorganic-organic hybrid aerogels. In particular, the inorganic-organic hybrid aerogels of the present disclosure are prepared by co-hydrolyzing and co-condensing a metal oxide precursor and an organo-functional metal oxide precursor; and crosslinking the functional groups. Hybrid aerogels and hybrid aerogel articles are also described.

### BACKGROUND

Aerogels are a unique class of ultra-low-density, highly porous materials. The high porosity, intrinsic pore structure, and low density make aerogels extremely valuable materials for a variety of applications including insulation. Low density aerogels based upon silica are excellent insulators as the very small convoluted pores minimize conduction and convection. In addition, infrared radiation (IR) suppressing dopants may easily be dispersed throughout the aerogel matrix to reduce radiative heat transfer.

Escalating energy costs and urbanization have lead to increased efforts in exploring more effective thermal and acoustic insulation materials for pipelines, automobiles, aerospace, military, apparel, windows, houses as well as other appliances and equipment. Silica aerogels also have high visible light transmittance so they are also applicable for heat insulators for solar collector panels.

### SUMMARY

Briefly, in one aspect, the present disclosure provides methods of preparing a hybrid aerogel. Generally, the methods include co-hydrolyzing and co-condensing a metal oxide precursor and an organo-functional metal oxide precursor to form a gel; and crosslinking organo-functional groups of the co-condensed organo-functional metal oxide with an ethylenically unsaturated crosslinking agent to form a hybrid aerogel precursor. The hybrid aerogel precursor can then be dried to form the hybrid aerogel.

In some embodiments, the gel is exposed to actinic radiation (e.g., ultraviolet radiation or electron beam irradiation) to crosslink the functional groups of the co-condensed organo-functional metal oxide with the ethylenically unsaturated crosslinking agent to form the hybrid aerogel precursor. In some embodiments, the gel is exposed to thermal energy to crosslink the functional groups of the co-condensed organo-functional metal oxide with the ethylenically unsaturated crosslinking agent to form the hybrid aerogel precursor. In some embodiments, a free radical initiator, e.g., a photoinitiator, may be used.

In some embodiments, the precursor of the metal oxide comprises an organosilane, e.g., an alkoxysilane such as a tetraalkoxysilane or an alkyltrialkoxysilane. In some embodiments, the precursor of the metal oxide comprises a pre-polymerized silicon alkoxide, e.g., a polysilicate.

In some embodiments, the precursor of the organo-functional metal oxide is an organosilane, e.g., an acryltrialkoxysilane.

In some embodiments, the ethylenically unsaturated crosslinking agent is a multi-functional (meth)acrylate.

In some embodiments, the methods further comprise solvent-exchanging the hybrid aerogel precursor with an alkyl alcohol to form an alcogel. In some embodiments, the hybrid aerogel precursor or the alcogel may be supercritically dried to form the hybrid aerogel. In some embodiments, the hybrid aerogel precursor or the alcogel may be ambient pressure dried to form the hybrid aerogel.

Generally, the metal oxide precursor, the organo-functional metal oxide precursor and the ethylenically unsaturated crosslinking agent are present in a sol further comprising a solvent. In some embodiments, the solvent comprises water and/or an alkyl alcohol.

In some embodiments, the sol comprises at least 1.5 mole % the precursor of the organo-functional metal oxide based on the total moles of the precursor of the metal oxide and the precursor of the organo-functional metal oxide. In some embodiments, the sol comprises no greater than 12 mole % of the precursor of the organo-functional metal oxide based on the total moles of the precursor of the metal oxide and the precursor of the organo-functional metal oxide.

In some embodiments, the sol also comprises at least one of a hydrophobic surface modifying agent and an acid.

In some embodiments, methods further comprise applying the sol to a substrate (e.g., a non-woven substrate or a bonded web) prior to forming the aerogel. In some embodiments, the sol is applied to the substrate prior to forming the aerogel precursor.

In another aspect, the present disclosure provides hybrid aerogels and hybrid aerogel articles made according to the methods of the present disclosure.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 is an SEM image of the aerogel of Comparative Example 1.

FIG. 2 is an SEM image of the hybrid aerogel of Example 2.

### DETAILED DESCRIPTION

In some literature, the terms “xerogel” and “aerogel” are used to describe nanoporous solids formed from a gel by drying. Generally, the distinction between xerogels and aerogels is based upon the porosity and density of the structures. Xerogels typically result from ambient drying processes where the surface tension of the solvent is believed to contribute to shrinkage of the pores during drying. The resulting xerogels usually retain moderate porosity (e.g., about 20 to 40%) and density (e.g., between 0.5 and 0.8 grams per cubic centimeter (g/cc)). Aerogels are typically formed when solvent removal occurs under hypercritical (supercritical) conditions, as the network generally does not shrink under such drying conditions. The resulting aerogels generally exhibit ultra-low-density (e.g., no greater than 0.4 g/cc, e.g., 0.1 to 0.2 g/cc), and high porosity e.g., at least 75%, e.g., at least 80%, or even 90% (e.g., 90-99%) porosity.

At intermediate levels of porosity and density, the use of the terms xerogel and aerogel can become arbitrary and confusing. Therefore, as used herein the term “aerogel” refers to a solid state substance similar to a gel except that the liquid dispersion medium has been replaced with a gas, e.g., air, and encompasses both aerogels and xerogels. Unless otherwise indicated, the term “aerogel” refers to the final product independent of the process used to arrive at the product and independent of the precise levels of porosity and density.

In some instances when the liquid of the gel has been removed at supercritical temperatures and pressures, the resulting materials may be referred to as “supercritical aerogels.” Similarly, in some instances materials formed through ambient drying processes may be referred to as “ambient aerogels.”

An “aerogel monolith” is a unitary structure comprising a continuous aerogel. Aerogel monoliths generally provide desirable insulating properties; however, they tend to be very fragile and lack the flexibility needed for many applications. Aerogel monoliths may also shed aerogel material, which can create handling problems.

Monolithic aerogels are typically supercritically dried to preserve the highly porous network without collapse. When forming a supercritical aerogel, the solvent or dispersant of the gel is removed at temperatures above the critical temperature and at pressures starting from a point above the critical pressure. As a result, the boundary between the liquid phase and the vapor phase is not crossed, and therefore no capillary forces are developed, which would otherwise lead to the collapse of the gel during the drying process. However supercritical drying can be expensive as it requires complex equipment and procedures.

The drying of the gels at ambient pressure provides an alternative approach. However, when forming such ambient aerogels, the solvent or dispersant is removed under conditions such that a liquid-vapor phase boundary is formed. The presence of capillary forces and lateral compressive stress during the subcritical drying often causes the gel to crack and shrink. The resulting 3-dimensional arrangement of the network of an ambient aerogel typically differs from that of a supercritical aerogel, e.g., the distances between the structural elements become much smaller.

Despite the structural disadvantages of an ambient aerogel compared to a supercritical aerogel, it is very desirable to provide supercritical aerogel-like characteristics with aerogels formed using ambient drying schemes. Specific, desirable characteristics include pore structure, density, and porosity.

Due in part to their low density inorganic structure (often >90% air), aerogels have certain mechanical limitations. For example, inorganic aerogels have a high stiffness and tend to be brittle. Previous attempts have been made to improve the mechanical properties of inorganic aerogels by introducing organic content via long and short chained linear and branched polymers and oligomers to form organic/inorganic “hybrid aerogels.” However these approaches have significant limitations such as insufficient or inefficient reinforcement, reinforcement at the cost of other desirable properties, laborious processes for making the reinforcing organics, and costly routes for commercial scale production.

In some applications it may be useful to use hydrophobic aerogels. Some gels (e.g., silica gels) are inherently hydrophilic and typically require post treatment to render them hydrophobic. The addition of the organic component of a hybrid aerogel can impart some hydrophobicity but the level of organics needed to ensure durable hydrophobicity is often so large that the desirable properties of the inorganic component (e.g., low density, high porosity, and low thermal conductivity) are compromised.

Generally, the methods of the present disclosure begin with a sol. Sols typically comprise one or more solvents, at least one precursor of a metal oxide, at least one precursor of an organo-functional metal oxide, and at least one ethylenically unsaturated crosslinking agent.

As used herein, the terms “precursor of a metal oxide” and “metal oxide precursor” are used interchangeably. These terms refer to a material that, when hydrolyzed and condensed, forms a metal oxide.

The methods and resulting aerogels of the present invention are not particularly limited to specific metal oxide precursors. In some embodiments, the metal oxide precursor comprises an organosilane, e.g., a tetraalkoxysilane. Exemplary tetraalkoxysilanes include tetraethoxysilane (TEOS) and tetramethoxysilane (TMOS). In some embodiments, the organosilane comprises an alkyl-substituted alkoxysilane, e.g., an alkyltrialkoxysilane such as methyltrimethoxysilane (MTMOS). In some embodiments, the organosilane comprises a pre-polymerized silicon alkoxide, e.g., a polysilicate such as ethyl polysilicate.

As used herein, the terms “precursor of an organo-metal oxide” and “organo-metal oxide precursor” are used interchangeably. These terms refer to a material that, when hydrolyzed and condensed, forms an organo-metal oxide, i.e., a metal oxide comprising organic groups. As used herein, if the organic groups are capable of reacting with the crosslinking agent, the organic groups are considered “functional.” The resulting metal oxide is then referred to as an “organo-functional metal oxide.”

The methods and resulting aerogels of the present disclosure are not particularly limited to specific organo-functional metal oxide precursors, provided the functional organic groups react with the crosslinking agent to form crosslinks. In some embodiments, the organo-functional metal oxide precursor comprises an organosilane. Exemplary organosilanes suitable for use as organo-functional metal oxide precursors include acrylsilanes, e.g., acryltrialkoxysilanes. One exemplary acryltrialkoxysilane is 3-methyacryloxypropyltrimethoxysilane.

In some embodiments, the sol comprises at least 1 mole % of the organo-functional metal oxide precursor based on the total moles of the metal oxide precursor and the organo-functional metal oxide precursor. In some embodiments, the sol comprises at least 1.5 mole %, or even at least 2.5 mole % of the organo-functional metal oxide precursor based on the total moles of the metal oxide precursor and the organo-functional metal oxide precursor. In some embodiments, the sol comprises no greater than 14 mole %, e.g., no greater 12 mole %, or even no greater than 11 mole % of the organo-functional metal oxide precursor based on the total moles of the metal oxide precursor and the organo-functional metal oxide precursor. For example, in some embodiments, the sol comprises between 1.5 and 12 mole %, e.g., between 2.5 and 11 mole %, or even between 5 and 10 mole % of the organo-functional metal oxide precursor based on the total moles of the metal oxide precursor and the organo-functional metal oxide precursor.

Ethylenically unsaturated crosslinking agents are well-known. In some embodiments, the crosslinking agent is a multi-functional (meth)acrylate, i.e., a crosslinking agent comprising two or more acrylate and/or methacrylate groups. Although diacrylates such as hexanedioldiacrylate (HDDA) may be used, in some embodiments, higher-order multi-functional acrylates such as triacrylates (e.g., trimethylolpropane triacrylate), tetraacrylates, pentaacrylates, and hexaacrylates may be preferred.

Generally, the metal oxide precursor and the organo-functional metal oxide precursor are co-hydrolyzed and co-condensed to form a gel. At this stage the gel comprises a first, metal oxide network with pendant functional organic groups. The pendant functional groups are then crosslinked via the ethylenically unsaturated crosslinking agents forming a second, organic network. Upon the formation of both the first inorganic metal oxide network and the second organic network, the structure is referred to herein as a “hybrid aerogel precursor.”

In some embodiments, the formation of the first inorganic metal oxide network and the second organic network may proceed as separate, sequential steps. For example, in some embodiments, the inorganic network may be formed first, followed by the formation of the organic network via crosslinking of the pendant organic groups. In some embodiments, there may be some, or even complete overlap of the steps. For example in some embodiments, at least some crosslinking of the organic groups may occur simultaneously with the co-condensation of the precursors and the formation of at least a portion of both networks may occur at the same time.

In some embodiments, the first inorganic metal oxide network and the second organic network are formed as interpenetrating networks.

In some embodiments, methods of the present disclosure include exposing the gel to actinic radiation to crosslink the functional groups of the co-condensed organo-functional metal oxide with the ethylenically unsaturated crosslinking agent to form the hybrid aerogel precursor. In some embodiments, ultraviolet light or electron beam irradiation may be used as the actinic radiation. In some embodiments, methods of the present disclosure include exposing the gel to thermal energy to crosslink the functional groups of the co-condensed organo-functional metal oxide with the ethylenically unsaturated crosslinking agent to form the hybrid aerogel precursor.

In some embodiments, an initiator, e.g., a free radical initiator may be used. In some embodiments, the initiator may be a photoinitiator. Exemplary photoinitiators include phosphine oxides such as 2,4,6-trimethylbenzoylethoxyphenylphosphine oxide.

Generally, the sol comprises at least one solvent. In some embodiments, the solvent comprises water. In some embodiments, one or more organic solvents such as an alkyl alcohol may be used. In some embodiments, the sol may include both water and one or more organic solvents, e.g., a water/alkyl alcohol blend. In some embodiments, the sol comprises at least two moles of water per mole of metal oxide precursor, e.g., at least three moles of water per mole of metal oxide precursor. In some embodiments, the sol comprises 2 to 5, e.g., 2 to 4, moles of water per mole of metal oxide precursor.

Following gel formation, solvent is removed, drying the hybrid aerogel precursor to provide the hybrid aerogel. As previously described, the selected method of drying, i.e., the method by which the solvent present in the gel is removed, determines whether an aerogel is a “supercritical aerogel” or an “ambient aerogel.” When forming a supercritical aerogel, the solvent or dispersant of the gel is removed at temperatures above the critical temperature and at pressures starting from a point above the critical pressure. Drying processes for producing supercritical aerogels are described in, e.g., S. S. Kistler: J. Phys. Chem., Vol. 36, 1932. In contrast, when forming an ambient aerogel, the solvent or dispersant is removed under conditions such that a liquid-vapor phase boundary is formed. Processes for drying gels to form xerogels are described in, e.g., Annu Rev. Mater. Sci., Vol. 20, p. 269 ff., 1990, and L. L. Hench and W. Vasconcelos: Gel-Silica Science.

In some embodiments, a solvent exchange step may precede the drying step. For example, it may be desirable to replace water present in the initial sol with other organic solvents. Generally, any known method of solvent exchange may be used with the methods of the present disclosure. Generally, it may be desirable to replace as much water as possible with the alternate organic solvent. However, as is commonly understood, it may be difficult, impractical, or even impossible to remove all water from the gel. In some embodiments, the exchange solvent may be an alkyl alcohol, e.g., ethyl alcohol. After solvent exchange with an organic solvent, the resulting gel is often referred to as an organogel as opposed to a hydrogel, which refers to a gel wherein the solvent is primarily water. When the exchange solvent is an alkyl alcohol, the resulting gel is often referred to as an alcogel.

In some embodiments, the hybrid aerogel is hydrophobic. A typical method for making aerogels hydrophobic involves first making a gel. Subsequently, this preformed gel is soaked in a bath containing a mixture of solvent and the desired hydrophobizing agent in a process often referred to as surface derivatization. For example, U.S. Pat. No. 5,830,387 (Yokogawa et al.) describes a process whereby a gel having the skeleton structure of (SiO₂)ₙ was obtained by hydrolyzing and condensing an alkoxysilane. This gel was subsequently hydrophobized by soaking it in a solution of a hydrophobizing agent dissolved in solvent. Similarly, U.S. Pat. No. 6,197,270 (Sonada et al.) describes a process of preparing a gel having the skeleton structure of (SiO₂)ₘ from a water glass solution, and subsequently reacting the gel with a hydrophobizing agent in a dispersion medium (e.g., a solvent or a supercritical fluid).

In some embodiments, hydrophobic aerogels can be prepared from sols containing a hydrophobic surface modifying agent. Such methods are described in co-filed U.S. Application No. (to be determined; Attorney Docket No. 64254US002).

Generally, during the gel formation process, the hydrophobic surface modifying agent combines with the inorganic metal oxide network to provide a hydrophobic surface. In some embodiments, the hydrophobic surface modifying agent is covalently bonded to the metal oxide network. In some embodiments, the hydrophobic surface modifying agent may be ionically bonded to the metal oxide network. In some embodiments, the hydrophobic surface modifying agent may be physically adsorbed to the metal oxide network.

Generally, the hydrophobic surface modifying agent comprises two functional elements. The first element reacts with (e.g., covalently or ionically) or absorbs on to the metal oxide network. The second element is hydrophobic. Exemplary hydrophobic surface modifying agents include organosilane, organotin, and organophosphorus compounds. One exemplary organosilane is 1,1,1,3,3,3-hexamethyldisilazane (HMDZ).

In some embodiments, the sol further comprises an acid. In some embodiments, the acid is an inorganic acid, e.g., hydrochloric acid. In some embodiments, the acid is an organic acid, e.g., oxalic acid. In some embodiments, the sol comprises between 0.0005 and 0.0010 moles of acid per mole of the metal oxide precursor. In some embodiments, comprises between 0.0006 and 0.0008 moles of acid per mole of the metal oxide precursor.

In some embodiments, the sol further comprises a branched telechelic polymer. Examples of branched telechelic polymers and methods of incorporating them in an aerogel are described in co-filed U.S. Application No. (to be determined, Attorney Docket No. 64255US002).

In addition to forming hybrid aerogels, the methods of the present disclosure may be used to form aerogel articles, e.g., flexible aerogel articles. For example, in some embodiments, the sol may be applied to a substrate prior to forming a gel. Gelation, solvent exchange (if used), and drying may then occur on the substrate.

In some embodiments, the substrate may be porous, e.g., a woven or nonwoven fabric. Exemplary substrates also include bonded web such as those described in U.S. patent application Ser. No. 11/781,635, filed Jul. 23, 2007.

### EXAMPLES

The following materials were used to produce exemplary hybrid aerogels according to some embodiments of the present disclosure.

TABLE 1
Summary of raw materials.

| Material | Description | Source |
|---|---|---|
| MTMOS | methyltrimethoxysilane (95%) | J. T. Baker |
| TEOS | tetraethoxysilane (>99%) | Alfa Aeser |
| Me0H | methanol (99.8%) | J. T. Baker |
| EtOH | ethanol (200 proof) | Aaper Alcohol |
| A174 | 3-(methyacryloxy)propyltrimethoxysilane | Alfa Aeser |
| | (97%) | |
| TMPTA | trimethylolpropane triacrylate crosslinker | Sartomer |
| TPO-L | 2,4,6-trimethylbenzoylethoxyphenyl- | BASF |
| | phosphine oxide | |
| OxA | oxalic acid | MP Biomedicals |
| HCl | hydrochloric acid | various |
| NH4OH | ammonium hydroxide | various |
| HMDZ | 1,1,1,3,3,3-hexamethyldisilazane (>99%) | Alfa Aesar |

The following test methods were used to characterize the aerogels.

Brunauer, Emmett, and Teller (BET). BET analysis was conducted using a AUTOSORB-1 model AS1MP-LP instrument and associated software (AS1Win version 1.53) available from Quantachrome Instruments (Boynton Beach, Fla.). Sample material was placed in a 9 mm sample tube with a uniform initial weight of approximately 0.0475 grams. The sample was degassed for at least 24 hours at 80° C. prior to analysis. Nitrogen was used as the analyte gas. The BJH method was applied to desorption data to determine pore volume and diameter.

Bulk Density. To enable measurement of bulk density, aerogel cylinders were synthesized within plastic syringes with one end cut off. Once gelled, the aerogel cylinder was extracted from the syringe using the syringe plunger and dried. The diameter and length of each dried cylinders was measured and the volume calculated. The weight of each sample was measured on an analytical balance. The bulk density was then calculated from the ratio of weight to volume.

Skeletal Density. The skeletal density was determined using a Micromeritics ACCUPYC 1330 helium gas pycnometer. The instrument uses Boyle's law of partial pressures in its operation. The instrument contains a calibrated volume cell internal to the instrument. The sample was placed in a sample cup, weighed and inserted into the instrument. The sample was pressurized in the instrument to a known initial pressure. The pressure was bypassed into the calibrated cell of the instrument and a second pressure recorded. Using the initial pressure, the second pressure, and the volume of the calibrated cell, the skeletal volume of the sample was determined. The skeletal density was then determined from the skeletal volume and the sample weight.

Porosity. The percent porosity was calculated from the measured bulk density (ρ_{bulk}) and the and skeletal density (ρₛₖₑₗₑₜₐₗ) using the following formula:

$$porosity ( \% ) = ( 1 - ( \frac{{ρ}_{bulk}}{{ρ}_{skeletal}} ) ) \times 100$$

Hydrophobicity. A small sample was placed in a jar containing deionized water at room temperature (about 22° C.). If the samples remained floating after 30 minutes, it was judged to be hydrophobic. If the sample was not floating after 30 minutes, it was judged to be non-hydrophobic.

Gels A-E: UV-cured hybrid wet gels.

Gels A-E were prepared as follows, according to the compositions described in Table 2. First, MTMOS (a metal oxide precursor), MeOH (a solvent), OxA (an acid as a 0.01 M solution), and A174 (an organo-functional metal oxide precursor) were combined in a glass jar, mixed with the aid of a magnetic stir bar for 20 minutes and placed on a shelf for 24 hours. After 24 hours, TMPTA (a crosslinker) was added and the solution was mixed for 20 minutes before adding TPO-L (a photoinitiator) and mixing for an additional 20 minutes. Then the NH4OH was added as a 10 M solution to initiate gelation and the composition was mixed for 20 minutes. The resulting composition was transferred into PYREX Petri dishes, sealed in plastic bags, placed in a dark area at room temperature allowed to gel for 24 hours.

TABLE 2
Formulations of Gels A-E.

| | Relative mole % | | | Wt. % (a) | Moles per mole MTMOS | | |
|---|---|---|---|---|---|---|---|
| Gel | MTMOS | A174 | TMPTA | TPO-L | MeOH | OxA | NH4OH |
| A | 100 | 0 | 0 | 0 | 28 | 0.0007 | 0.73 |
| B | 95 | 2.5 | 2.5 | 1 | 28 | 0.0007 | 0.73 |
| C | 90 | 5 | 5 | 1 | 28 | 0.0007 | 0.73 |
| D | 85 | 7.5 | 7.5 | 1 | 28 | 0.0007 | 0.73 |
| E | 80 | 10 | 10 | 1 | 28 | 0.0007 | 0.73 |

(a) 1 part by weight (pbw) TPO-L per 100 pbw (A174 + TMPTA)

After gelation, a small amount of MeOH was added to the top of the gelled sample to prevent drying during a nitrogen purge of the plastic bag. After the nitrogen purge, the hybrid samples were exposed to ultraviolet (UV) radiation for 30 minutes to cure. After the cure, the samples were transferred to glass jars filled with MeOH. A solvent exchange was performed every 12 hours for two days (i.e., a total of 4 exchanges).

### Comparative Example 1 (CE-1) and Examples 1-4

### Supercritical Aerogels

Gels A-E were supercritically dried according to the following Supercritical Fluid Drying procedure. The properties of the resulting supercritical aerogels are summarized in Table 3.

Supercritical Fluid Drying. The sample was weighed and placed in a permeable cloth bag sealed with a draw string and placed inside a stainless steel chamber fitted with metal frits and O-rings. This chamber was inserted into a vessel rated to handle high pressure (40 MPa (6000 psig)). The outside of this vessel was heated by a jacket. Carbon dioxide was chilled to less than minus 10 degrees Celsius and pumped with a piston pump at a nominal flow rate of one liter per minute through the bottom of the unit. After ten minutes, the temperature of the unit was raised to 40° C. at a pressure of 10.3 MPa (1500 psig). The carbon dioxide was supercritical at these conditions. Drying was conducted for a minimum of seven hours, after which the carbon dioxide flow was ceased and the pressure was slowly decreased by venting the carbon dioxide. When the pressure was at 370 kPa (40 psig) or lower, the supercritically-dried aerogels were removed and weighed.

TABLE 3
Characteristics of the supercritical aerogels of
CE-1, and Examples 1-4.

| | | | bulk | skeletal | | |
|---|---|---|---|---|---|---|
| | | MTMOS | density | density | porosity | |
| Ex. | Gel | (mole %) | (g/cc) | (g/cc) | (%) | hydrophobic |
| CE-1 | A | 100 | 0.091 | 1.66 | 94 | Yes |
| 1 | B | 95 | 0.098 | 1.56 | 94 | Yes |
| 2 | C | 90 | 0.105 | 1.59 | 93 | Yes |
| 3 | D | 85 | 0.123 | 1.52 | 92 | Yes |
| 4 | E | 80 | 0.157 | 1.46 | 89 | Yes |

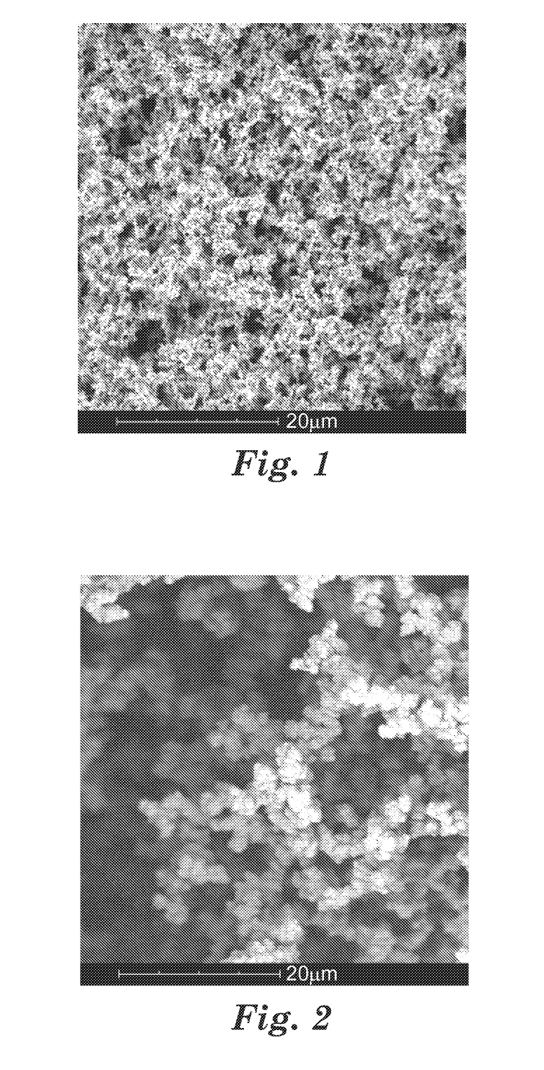

A scanning electron microscope was used to obtain images at 5000× magnification of an aerogel and one exemplary hybrid aerogel according to some embodiments of the present disclosure. The aerogel of Comparative Example CE-1 is shown in FIG. 1, and the exemplary hybrid aerogel of Example 2 is shown in FIG. 2.

### Comparative Example 2 (CE-2) and Examples 5-8

### Ambient Aerogels

Gels A-E were dried using the following Ambient Pressure Drying procedure. The properties of the resulting ambient aerogels are summarized in Table 4. With the exception of the unhybridized sample (CE-2) all samples had the low densities and high porosities characteristic of supercritical aerogels.

Ambient Pressure Drying. The sample was placed is a shallow jar with a lid. A hole was punched in the lid to allow the solvent to escape slowly to create a quasi-saturated solvent environment. The samples were subject to the following drying sequence: (a) room temperature for 24 hours; followed by (b) 60° C. for 12 hours; followed by 100° C. for 24 hours. All drying steps were performed at ambient pressure.

TABLE 4
Characteristics of the ambient aerogels of
CE-2 and Examples 5-8.

| | | | bulk | skeletal | | |
|---|---|---|---|---|---|---|
| | | MTMOS | density | density | porosity | |
| Ex. | Gel | (mole %) | (g/cc) | (g/cc) | (%) | hydrophobic |
| CE-2 | A | 100 | 0.969 | 1.38 | 30 | Yes |
| 5 | B | 95 | 0.136 | 1.45 | 91 | Yes |
| 6 | C | 90 | 0.154 | 1.42 | 89 | Yes |
| 7 | D | 85 | 0.195 | 1.44 | 86 | Yes |
| 8 | E | 80 | 0.219 | 1.38 | 84 | Yes |

Gel precursors F-I were made according to the formulations of Table 5. First, MTMOS, MeOH, OxA (0.01 M solution), and A174 were added to a glass jar mixed with the aid of a magnetic stir bar for 20 minutes, and placed on a shelf for 24 hours. After 24 hours, a crosslinker (TMPTA) was added and the solution mixed for 20 minutes before adding a photoinitiator (TPO-L) and mixing for an additional 20 minutes. Then NH4OH (10 M solution) was added and the composition was mixed for 20 minutes.

TABLE 5
Formulations for composite gels F-I.

| Gel | Relative mole % | | | wt. % (a) | moles per mole MTMOS | | |
|---|---|---|---|---|---|---|---|
| precursor | MTMOS | A174 | TMPTA | TPO-L | MeOH | OxA | NH4OH |
| F | 95 | 2.5 | 2.5 | 1 | 28 | 0.0007 | 0.73 |
| G | 90 | 5 | 5 | 1 | 28 | 0.0007 | 0.73 |
| H | 85 | 7.5 | 7.5 | 1 | 28 | 0.0007 | 0.73 |
| I | 80 | 10 | 10 | 1 | 28 | 0.0007 | 0.73 |

(a) 1 pbw TPO-L per 100 pbw (A174 + TMPTA)

### Examples 9-12

### Ambient Aerogel Composites

Gel precursors F-I were poured onto pieces of a substrate, sealed in plastic bags, placed in a dark area at room temperature, and allowed to gel for 24 hours. In each case, the substrate was a flexible, bonded fibrous substrate made of a 75-25 blend of 3d WELLMAN PET fibers and 6d KOSA PET fibers at 30 grams per square meter (gsm) that was carded, corrugated and bonded to 30 gsm of PP 7C05N strands wherein the corrugating pattern had 10 bonds per 2.54 cm (i.e., 10 bonds per inch). Details of forming such a substrate can be found in U.S. Pat. Nos. 6,537,935 and 5,888,607.

After gelation, a small amount of MeOH was added to the top of the gelled samples to prevent drying during a nitrogen purge of the plastic bag. After the nitrogen purge, the samples were exposed to ultraviolet (UV) radiation for 30 minutes to cure. After the cure, the samples were transferred to glass jars filled with MeOH. A solvent exchange was performed every 12 hours for 2 days (i.e., 4 total exchanges).

The resulting gels were then dried according to the Ambient Drying Procedure. The thermal conductivities of the resulting ambient aerogel composites are summarized in Table 6.

TABLE 6
Thermal conductivities of ambient aerogel composites.

| | | | | | thermal |
|---|---|---|---|---|---|
| | gel | MTMOS | thickness | temperature | conductivity |
| Ex. | precursor | (mol %) | (mm) | (° C.) | (mW/m-K) |
| 9 | F | 95 | 1.3 | 12.5 | 25.4 |
| 10 | G | 90 | 1.1 | 12.5 | 21.9 |
| 11 | H | 85 | 1.0 | 12.5 | 19.6 |
| 12 | I | 80 | 1.2 | 12.5 | 23.9 |

### Comparative Example CE-3 and Examples 13-15

### Supercritical Aerogels

The UV-cured hybrid supercritical aerogels of Comparative Example CE-3 and Examples 13-15 were prepared from gels according to the formulations summarized in Table 7.

TABLE 7
Formulations for Examples 13-16.

| Gel of | relative mole % | | | wt. % (a) | moles per mole TEOS | | | |
|---|---|---|---|---|---|---|---|---|
| Ex. | TEOS | A174 | TMPTA | TPO-L | EtOH | H2O | HCl | NH4OH |
| CE-3 | 100 | 0 | 0 | 0 | 5 | 3 | 0.0007 | 0.0017 |
| 13 | 97.5 | 1.25 | 1.25 | 1 | 5 | 3 | 0.0007 | 0.0017 |
| 14 | 95 | 2.5 | 2.5 | 1 | 5 | 3 | 0.0007 | 0.0017 |
| 15 | 90 | 5 | 5 | 1 | 5 | 3 | 0.0007 | 0.0017 |

(a) 1 pbw TPO-L per 100 pbw (A174 + TMPTA)

Gel Preparation Procedure. To a glass jar were added TEOS, EtOH, deionized water (H2O), HCl (1 M solution), and A174. The solution was mixed in the glass jar for a couple minutes with the aid of a magnetic stir bar and then transferred to a 500 milliliter round bottom 3-neck flask. The flask containing the solution was then placed in a 70° C. preheated oil bath and mixed for 90 minutes with reflux. After heating, the solution was returned to the glass jar, which had been rinsed with ethanol, and sealed. The jar containing the solution was immersed in cold tap water and cooled to room temperature. Once cooled, a crosslinker (TMPTA) was added to the solution and mixed for 20 minutes before adding a photoinitiator (TPO-L) and mixing for an additional 20 minutes.

Following the Gel Preparation Procedure, NH4OH (0.1 M solution) was added to the solution, which was then mixed for 1 minute, poured into PYREX Petri dishes, placed into plastic bags, and sealed. The samples gelled after several minutes. After gelation, a small amount of EtOH was added to the top of the gelled sample to prevent drying during a nitrogen purge of the plastic bag.

After the nitrogen purge, the sample was exposed to ultraviolet (UV) radiation for 30 minutes to cure. After the cure, the sample was transferred to a glass jar filled with EtOH and aged for 24 hours at 60° C. A solvent exchange was then performed every 12 hours for two days (i.e., 4 total exchanges). The samples were then dried using the Supercritical Fluid Drying procedure. The sample characteristics are included in Table 8.

TABLE 8
Characteristics of Examples 13-16.

| | TEOS | surface area | pore volume | |
|---|---|---|---|---|
| Ex. | (mole %) | (m²/g) | (cc/g) | hydrophobic |
| CE-3 | 100 | 1080 | 2.5 | No |
| 13 | 97.5 | 1121 | 3.8 | No |
| 14 | 95 | 970 | 3.0 | No |
| 15 | 90 | 722 | 2.0 | No |

### Comparative Example 4 (CE-4) and Examples 16-18

### UV-Cured Hybrid Supercritical Aerogels Surface Treated Prior to Gelation

The gels of comparative Example 4 and Examples 16-18 were prepared according to the formulations of Table 9. To a glass jar were added TEOS, EtOH, deionized water (H2O), HCl (1 M solution), and A174. The Gel Preparation Procedure was used to prepare the solutions. Following the gel preparation procedure, the HMDZ was added and the solution was mixed for 10 seconds, poured into PYREX Petri dishes, placed into plastic bags, and sealed. The samples gelled in less than 1 minute. After gelation, EtOH was added to the top of the gelled sample to prevent drying during a nitrogen purge of the plastic bag.

1,1,1,3,3,3-hexamethyldisilazane (HMDZ) was used as a silylating/surface modifying agent to render the silica gel hydrophobic. In principle, other silylating agents can also be used for this purpose. The silylating agent here performs the dual role of modifying the surface and providing ammonia upon reaction with water, which acts as a catalyst for the hydrolysis and condensation of the silica precursor.

After the nitrogen purge, the sample was exposed to ultraviolet (UV) radiation for 30 minutes to cure. The cured sample was aged for 24 hours at 60° C. A solvent exchange was then performed every 12 hours for 2 days (i.e., 4 total exchanges). The sample was then dried using a Supercritical Fluid Drying procedure.

TABLE 9
Formulations for CE-4 and Examples 16-18.

| Gel | relative mole % | | | wt. % (a) | moles per mole TEOS | | | |
|---|---|---|---|---|---|---|---|---|
| of Ex. | TEOS | A174 | TMPTA | TPO-L | EtOH | H2O | HCl | HMDZ |
| CE-4 | 100 | 0 | 0 | 0 | 5 | 3 | 0.0007 | 0.33 |
| 16 | 97.5 | 1.25 | 1.25 | 1 | 5 | 3 | 0.0007 | 0.33 |
| 17 | 95 | 2.5 | 2.5 | 1 | 5 | 3 | 0.0007 | 0.33 |
| 18 | 90 | 5 | 5 | 1 | 5 | 3 | 0.0007 | 0.33 |

(a) 1 pbw TPO-L per 100 pbw (A174 + TMPTA)

The surface areas and pore are summarized in Table 10. All of the samples were hydrophobic.

TABLE 10
Characteristics of CE-4 and Examples 16-18.

| | surface area | pore volume | |
|---|---|---|---|
| Ex. | (m²/g) | (cc/g) | hydrophobic |
| CE-4 | 846 | 1.4 | Yes |
| 16 | 723 | 0.9 | Yes |
| 17 | 660 | 1.1 | Yes |
| 18 | 358 | 0.4 | Yes |

### Comparative Example 5 (CE-5) and Examples 19 and 20

### UV-Cured Hybrid Supercritical aerogels

Comparative Example 5 and Examples 19 and 20 were prepared according to the formulations summarized in Table 11. To a glass jar were added TEOS, EtOH, deionized water (H2O), HCl (1 M solution), and A174. The Gel Preparation Procedure was used to prepare the solutions.

TABLE 11
Formulations for Examples CE-5 and Examples 19 and 20.

| Gel | relative mole % | | | wt. % (a) | moles per mole TEOS | | | |
|---|---|---|---|---|---|---|---|---|
| of Ex. | TEOS | A174 | TMPTA | TPO-L | EtOH | H2O | HCl | NH4OH |
| CE-5 | 100 | 0 | 0 | 0 | 5 | 3 | 0.0007 | 0.0017 |
| 19 | 97.5 | 1.25 | 1.25 | 1 | 5 | 3 | 0.0007 | 0.0017 |
| 20 | 95 | 2.5 | 2.5 | 1 | 5 | 3 | 0.0007 | 0.0017 |

(a) 1 pbw TPO-L per 100 pbw (A174 + TMPTA)

After adding NH4OH (0.1 M solution), the solution was mixed for 1 minute, poured into PYREX Petri dishes, placed into plastic bags, and sealed. The samples gelled after several minutes. After gelation, a small amount of EtOH was added to the top of the gelled sample to prevent drying during a nitrogen purge of the plastic bag.

After the nitrogen purge, the sample was exposed to ultraviolet (UV) radiation for 30 minutes to cure. After the cure, the sample was transferred to a glass jar filled with EtOH and aged for 24 hours at 60° C. A solvent exchange was then performed every 12 hours for 2 days (i.e., 4 total exchanges). The sample was then dried using the Supercritical Fluid Drying procedure.

The properties of the resulting hybrid supercritical are summarized in Table 12. The samples were not hydrophobic.

TABLE 12
Characteristics of CE-5 and Examples 19 and 20.

| | TEOS | bulk density | skeletal density | porosity | |
|---|---|---|---|---|---|
| Ex. | (mol %) | (g/cc) | (g/cc) | (%) | hydrophobic |
| CE-5 | 100 | 0.280 | 1.66 | 83 | No |
| 19 | 97.5 | 0.356 | 1.63 | 78 | No |
| 20 | 95 | 0.386 | 1.64 | 76 | No |

### Comparative Example 6 (CE-6) and Example 21

### UV-Cured Hybrid Supercritical Aerogels Surface Treated Prior to Gelation

Comparative Example 6 and Example 21 were prepared according to the formulations summarized in Table 13. To a glass jar were added TEOS, EtOH, deionized water (H2O), HCl (1 M solution), and A174. The Gel Preparation Procedure was used to prepare solutions.

TABLE 13
Formulations for CE-6 and Example 21.

| Gel of | relative mole % | | | wt. % (a) | moles per mole TEOS | | | |
|---|---|---|---|---|---|---|---|---|
| Ex. | TEOS | A174 | TMPTA | TPO-L | EtOH | H2O | HCl | HMDZ |
| CE-6 | 100 | 0 | 0 | 0 | 5 | 3 | 0.0007 | 0.33 |
| 21 | 97.5 | 1.25 | 1.25 | 1 | 5 | 3 | 0.0007 | 0.33 |

(a) 1 pbw TPO-L per 100 pbw (A174 + TMPTA)

HMDZ was added and the solution mixed for 10 seconds, poured into PYREX Petri dishes, placed into plastic bags, and sealed. The samples gelled in less than 1 minute. After gelation, a small amount of EtOH was added to the top of the gelled sample to prevent drying during a nitrogen purge of the plastic bag.

After the nitrogen purge, the sample was exposed to ultraviolet (UV) radiation for 30 minutes to cure. After the cure, the sample was transferred to a glass jar filled with EtOH and aged for 24 hours at 60° C. A solvent exchange was then performed every 12 hours for 2 days (i.e., 4 total exchanges). The sample was then dried using the Supercritical Fluid Drying procedure.

The properties of the hybrid supercritical aerogels are summarized in Table 14. The samples were hydrophobic.

TABLE 14
Characteristics of CE-5 and Example 22.

| | TEOS | bulk density | skeletal density | porosity | |
|---|---|---|---|---|---|
| Ex. | (mol %) | (g/cc) | (g/cc) | (%) | hydrophobic |
| CE-6 | 100 | 0.637 | 1.50 | 57 | Yes |
| 21 | 97.5 | 0.685 | 1.52 | 55 | Yes |

### Comparative Example 7 (CE-7)

### UV-Cured Supercritical Aerogel

Comparative Example 7 was prepared according to the formulation summarized in Table 15. To a glass jar were added TEOS, EtOH, deionized water (H2O), and HCl (1 M solution). The Gel Preparation Procedure was used to prepare the solution. After adding NH4OH (0.1 M solution), the solution was mixed for 1 minute, poured into PYREX Petri dish, placed into a plastic bag, and sealed. The sample was allowed to gel over night. The sample was then transferred to a glass jar filled with EtOH and aged for 24 hours at 60° C. A solvent exchange was then performed every 12 hours for 2 days (i.e., 4 total exchanges). The sample was then dried using the Supercritical Fluid Drying procedure.

TABLE 15
Formulation for Comparative Example CE-7.

| Gel | relative mole % | | | wt. % (a) | moles per mole TEOS | | | |
|---|---|---|---|---|---|---|---|---|
| of Ex. | TEOS | A174 | TMPTA | TPO-L | EtOH | H2O | HCl | NH4OH |
| CE-7 | 100 | 0 | 0 | 0 | 5 | 3 | 0.0007 | 0.0017 |

(a) 1 pbw TPO-L per 100 pbw (A174 + TMPTA)

### Examples 22 and 23

### UV-Cured Hybrid Supercritical Aerogels

Examples 22 and 23 were prepared according to the formulations summarized in Table 16. To a glass jar were added TEOS, EtOH, deionized water (H2O), HCl (1 M solution), and A174. The Gel Preparation Procedure was used to prepare solutions. After adding HMDZ, the solution mixed for 10 seconds and poured into PYREX Petri dishes, placed into plastic bags, and sealed. The samples gelled in less than 1 minute. After gelation, a small amount of EtOH was added to the top of the gelled sample to prevent drying during a nitrogen purge of the plastic bag.

After the nitrogen purge, the sample was exposed to ultraviolet (UV) radiation for 30 minutes to cure. After the cure, the sample was transferred to a glass jar filled with EtOH and aged for 24 hours at 60° C. A solvent exchange was then performed every 12 hours for two days (i.e., 4 total exchanges). The sample was then dried using the Supercritical Drying procedure.

TABLE 16
Formulations for Examples 22 and 23.

| Gel of | relative mole % | | | wt. % (a) | moles per mole TEOS | | | |
|---|---|---|---|---|---|---|---|---|
| Ex. | TEOS | A174 | TMPTA | TPO-L | EtOH | H2O | HCl | HMDZ |
| 22 | 95 | 2.5 | 2.5 | 1 | 5 | 3 | 0.0007 | 0.33 |
| 23 | 90 | 5 | 5 | 1 | 5 | 3 | 0.0007 | 0.33 |

(a) 1 pbw TPO-L per 100 pbw (A174 + TMPTA)

The thermal conductivity of comparative example (CE-7) and the hybrid aerogel samples (Examples 22 and 23) are summarized in Table 17.

TABLE 17
Thermal conductivity of CE-7 and Examples 22 and 23.

| | TEOS | thickness | temperature | thermal conductivity |
|---|---|---|---|---|
| Ex. | (mol %) | (mm) | (° C.) | (mW/m-K) |
| CE-7 | 100 | 1.3 | 12.5 | 19.9 |
| 22 | 95 | 1.5 | 12.5 | 26.5 |
| 23 | 90 | 2.3 | 10.0 | 34.5 |

The above representative examples demonstrate that both hydrophobic and non-hydrophobic, hybrid aerogels with a range of thermal conductivities can be made using the compositions and process described herein. Both supercritical aerogels and ambient aerogels, including flexible supercritical aerogel composites and flexible ambient aerogel composites can be produced.

Various modifications and alterations of this invention will become apparent to those skilled in the art without departing from the scope and spirit of this invention.

1. A method of preparing a hybrid aerogel comprising
(a) providing a sol comprising a solvent, a precursor of a metal oxide, a precursor of a organo-functional metal oxide, and an ethylenically unsaturated crosslinking agent;
(b) co-hydrolyzing and co-condensing the metal oxide precursor and the organo-functional metal oxide precursor to form a gel;
(c) crosslinking organo-functional groups of the co-condensed organo-functional metal oxide with the ethylenically unsaturated crosslinking agent to form a hybrid aerogel precursor; and
(d) drying the hybrid aerogel precursor to form the hybrid aerogel.

2. The method of claim 1, further comprising exposing the gel to actinic radiation to crosslink the functional groups of the co-condensed organo-functional metal oxide with the ethylenically unsaturated crosslinking agent to form the hybrid aerogel precursor.

3. (canceled)

4. (canceled)

5. The method of claim 1, comprising exposing the gel to thermal energy to crosslink the organo-functional groups of the co-condensed organo-functional metal oxide with the ethylenically unsaturated crosslinking agent to form the hybrid aerogel precursor.

6. The method according to claim 1, wherein the sol further comprises a free radical initiator.

7. (canceled)

8. The method according to claim 1 wherein the precursor of the metal oxide comprises a first organosilane.

9. The method of claim 8, wherein the first organosilane comprises an alkoxysilane selected from the group consisting of tetraethoxysilane, tetramethoxysilane and combinations thereof; and (b) methyltrimethoxysilane.

10. (canceled)

11. (canceled)

12. The method of claim 8, wherein the precursor of the metal oxide comprises a pre-polymerized silicon alkoxide, optionally wherein the pre-polymerized silicon alkoxide comprises a polysilicate.

13. The method according to claim 1 wherein the precursor of the organo-functional metal oxide is a second organosilane.

14. The method according to claim 13, wherein the second organosilane comprises an acryltrialkoxysilane, optionally wherein the acryltrialkoxysilane is 3-methyacryloxypropyltrimethoxysilane.

15. The method according to claim 1 wherein the crosslinking agent is a multi-functional (meth)acrylate.

16. The method according to claim 1, further comprising solvent-exchanging the hybrid aerogel precursor with an alkyl alcohol to form an alcogel.

17. The method according to claim 1, further comprising supercritically drying the aerogel precursor or the alcogel to form the hybrid aerogel.

18. (canceled)

19. The method according to claim 1, wherein the solvent comprises water, optionally wherein the sol comprises at least three moles of water per mole of the metal oxide precursor.

20. The method according to claim 1, wherein the solvent comprises an alkyl alcohol.

21. (canceled)

22. The method according to claim 1, wherein the sol comprises at least 1.5 mole and no greater than 12 mole % of the precursor of the organo-functional metal oxide based on the total moles of the precursor of the metal oxide and the precursor of the organo-functional metal oxide.

23. (canceled)

24. The method according to claim 1, wherein the sol comprises a hydrophobic surface modifying agent.

25. (canceled)

26. The method according to claim 1, further comprising applying the sol to a substrate prior to forming the aerogel.

27. The method of claim 26, wherein the sol is applied to the substrate prior to forming the aerogel precursor.

28. (canceled)

29. (canceled)

30. A hybrid aerogel article made according to the method of claim 26.

31. A hybrid aerogel made by the method according of claim 1, wherein the aerogel has a porosity of at least 75% to 25.

32. (canceled)
